(19) United States
(12) Patent Application Publication
(10) Pub. No.: US 2003/0213791 A1
(43) Pub. Date: Nov. 20, 2003

(54) Toaster having guides with bread supports

(75) Inventors: Thomas G. Guyett, Gainesville, GA (US); Paul A. Disalvo, Lake Worth, FL (US)

Correspondence Address: LEYDIG, VOIT & MAYER, LTD., (SEATTLE OFFICE), TWO PRUDENTIAL PLAZA, SUITE 4900, CHICAGO, IL, 60601-6780, US

(73) Assignee: Sunbeam Products, Inc.

(21) Appl. No.: 10/151,645

(22) Filed: May 20, 2002

(51) Int. Cl. A47J 37/08

(52) U.S. Cl. 219/386; 219/392; 219/412; 99/332; 99/337

(57) ABSTRACT

A safety mechanism for a toaster that permits breaking of the circuit to the heating elements of the toaster even when a piece of toast is jammed within one of the slots of the toaster. A support surface is provided upon which a piece of bread rests as the bread carrier moves downward in the toaster. The support surface is arranged so that the bread carrier may continue to move downward after the bread is resting on the support surface. The vertical separation between the bread carrier in its lowermost position and the bottom of the bread that is resting on the support surface permits the bread carrier to move a sufficient amount to release the contact or contacts prior to the bread carrier engaging the bread.

### TECHNICAL FIELD OF THE INVENTION

The present invention is directed to kitchen appliances, and more specifically to toasters.

### BACKGROUND OF THE INVENTION

A toaster is a kitchen appliance that uses electrical heat to brown bread, bagels, and other foods. Toasters cook with heating elements that radiate heat by having an electrical current passed through them. The heating elements are usually made of electrical wires wrapped around mica panels. Bread is placed into a slot through the top of the toaster and rests on top of a bread carriage. When the bread is fully inside the slots and between the heating elements, the bread carriage is latched into place. An electrical current is supplied to the heating elements, which in turn heat and cook the bread.

In modern toaster designs, as a piece of bread is lowered into the toaster, a pair of wire grid toast guides move inwardly from opposite sides of the bread to gently center and hold the bread in position as it is being toasted. These wire grid toast guides typically pivot about a pivot point at the base of the toaster. The pivoting action is produced as a user mechanically pushes a handle on the toaster from an up position to a down position to lower the bread carrier and bread into the toaster.

Very often, the electrical current to the heating elements is activated by the bread carrier engaging a switch at the lowermost point of downward movement of the bread carrier. The switch is typically arranged such that it is mechanically engaged by the bread carrier when the bread carrier is in the down position. The switch may be, for example, in the form of a mechanical lever, which, when engaged by the bread carrier in its lowermost position, rotates to cause spring contacts to come into contact with supply contacts, thereby supplying an electrical current to the heating elements. After the toasting cycle, the bread carriage is released, and the toasted bread and the bread carriage rise until the toasted bread extends out of the slots through the top of the toaster. The toasted bread is then ready to be grabbed by a user.

Although conventional toasters work well for their intended purpose, a problem can arise when the toasting cycle has been completed. Occasionally, after the bread carriage is released, the bread carriage gets stuck as it is moving upward, for example by a piece of toasted bread getting lodged in the upper portion of one of the slots. In such an occurrence, the bread carrier is prevented from fully moving upward. The mechanical lever or other switching mechanism that is connected to the bread carrier is not released, causing the spring contacts to remain in contact with the supply contacts. Thus, the heating elements continue to received power, and the piece of bread within the toaster continues to toast and can actually burn.

### SUMMARY OF THE INVENTION

The present invention provides a safety mechanism for a toaster that permits breaking of the circuit to the heating elements of the toaster even when a piece of toast is jammed within one of the slots of the toaster. To this end, the present invention provides a support surface upon which a piece of bread rests as the bread carrier moves downward in the toaster. The support surface is arranged so that the bread carrier may continue to move downward after the bread is resting on the support surface. In this continued movement downward, the bread carrier separates vertically from the piece of bread. During this continued downward movement, the bread carrier activates a switch, such as a contact or pair of contacts, to turn on the heating elements.

The vertical separation between the bread carrier in its lowermost position and the bottom of the bread that is resting on the support surface permits the bread carrier to move a sufficient amount to release the contact or contacts prior to the bread carrier engaging the bread. In this manner, the power to the electrical contacts is broken before the bread carriage engages the bread. Should a piece of bread become jammed in the toaster at the completion of toasting, the fact that the power has been cut to the electrical contacts prevents the bread from being burnt by the heating elements.

In accordance with one aspect of the present invention, the support surface is provided as support elbows located partway up wired toast guides for the toaster. In this embodiment, the bread is lowered into the toaster, and the wire guide support elbows pivot inwardly to capture the bread. The wire guide support elbows are positioned such that they allow the bread carrier to continue its downward travel beneath the piece of bread.

The present invention provides a relatively inexpensive way to prevent a jammed piece of bread in a toaster from causing heating elements to continue to heat, thus preventing accidental burning by the toaster. The support surfaces of the present invention may be utilized in most conventional toaster designs, permitting this safety feature to be incorporated in a conventional toaster without altering the circuitry or the bread carriage components of the toaster.

Other advantages will become apparent from the following detailed description when taken in conjunction with the drawings, in which:

### BRIEF DESCRIPTION OF THE DRAWINGS

FIG. 1 shows a side perspective view of a toaster incorporating the present invention, with a portion of the toaster removed for detail;

FIG. 2 shows a side schematic view of the internal components of the toaster of FIG. 1, with bread shown at a beginning stage of entering the toaster;

FIG. 3 shows a side schematic of the toaster of FIG. 1, similar to FIG. 2, with the bread lowered into the toaster;

FIG. 4 is a side schematic view of the internal components of the toaster of FIG. 1, showing a piece of bread lodged as it is being ejected from the toaster;

FIG. 5 is an end view of some internal components of the toaster of FIG. 1, with the bread shown in the position of FIG. 2;

FIG. 6 is an end view of some internal components of the toaster of FIG. 2, similar to FIG. 5, with the bread shown in a lower position; and

FIG. 7 is an end view, similar to FIGS. 5 and 6, showing the bread lowered into the position shown in FIG. 3.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details. Furthermore, well-known features may be omitted or simplified in order not to obscure the present invention. In addition, to the extent that orientations of the invention are described, such as “top,” “bottom,” “front,” “rear,” and the like, the orientations are to aid the reader in understanding the invention, and are not meant to be limiting.

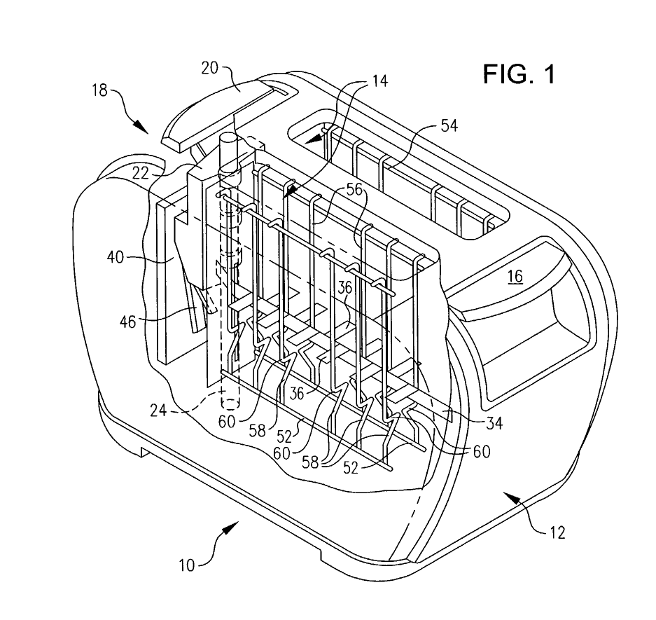

Referring now to the drawings, which like reference numerals represent like parts throughout the several views, FIG. 1 generally shows a toaster 10 incorporating the present invention. The toaster 10 includes an outer casing or housing 12, typically made of metal, plastic, or another suitable material. The housing 12 includes slots 14 arranged on its upper surface and configured to permit access to the inside of the housing. The slots 14 are situated so that they point upward, but other suitable arrangements may be provided.

In the embodiment shown in FIG. 1, the toaster 10 includes generally rounded sidewalls and a carrying handle 16 on the upper, back side of the toaster 10. Other configurations for the toaster 10 may be provided, as are generally known in the toaster art.

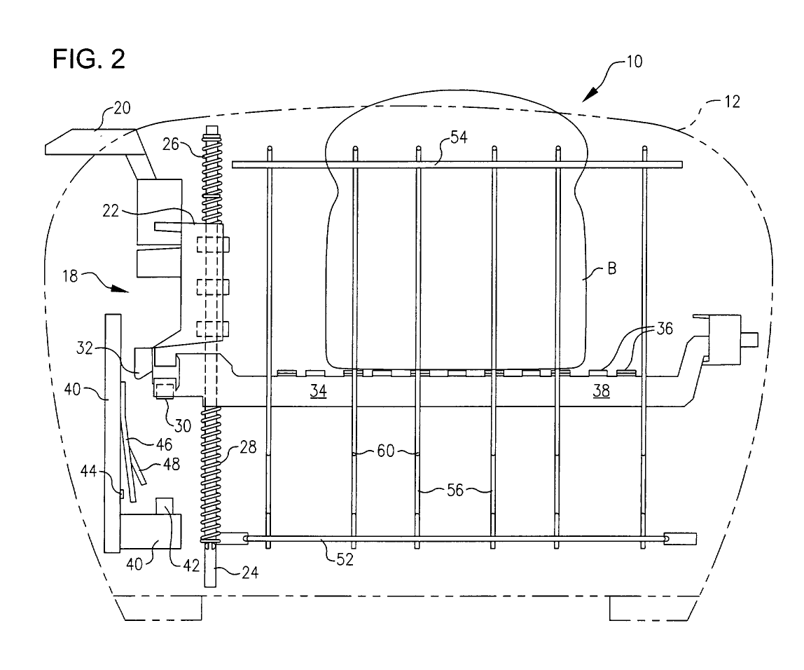

Turning now to FIG. 2, the toaster 10 includes a bread carriage, denoted generally by the reference numeral 18. The bread carriage 18 includes an actuation handle 20 that extends outside of the housing 12 for the toaster 10. The handle 20 is attached to a body 22 that is arranged for sliding up and down a rod 24. The body 22 and the rod 24 are located inside the housing 12. An upper spring 26 extends around the rod 24 and abuts against the top of the body 22 and against the underside of the top of the housing 12. Similarly, a lower spring 28 extends around the rod 24 and abuts against the bottom of the body 22 and against a portion of a frame for the toaster 10 located near the bottom of the housing 12.

An electromagnetic contact 30 is attached to the bottom of the body 22. An abutment 32 extends just forward of the electromagnetic contact 30 and outward from the body 22. A bread bracket 34 extends rearwardly from the body 22 and along the length of the housing 12. The bread bracket 34 shown in the drawings includes alternating, offset gear teeth 36 mounted along an elongate flat rod 38.

An L-shaped platform 40 is attached to the frame of the toaster 10 and is mounted on the front end of the toaster, inside the housing 12, and just below the actuation handle 20. An electromagnetic latch 42 is mounted on a rearward portion of the L-shaped platform 40. The electromagnetic latch 42 is arranged directly under the electromagnetic contact 30 on the body 22 of the bread carriage 18.

A supply contact 44 is arranged on a rearward face of the vertical portion of the L-shaped platform 40. A spring contact 46 is attached above the supply contact 44 and extends to just outward and beyond the supply contact 44. An outwardly extending flange 48 extends rearwardly from the spring contact 46, and is arranged so that it may be engaged by the abutment 32 on downward movement of the bread carriage 18.

In operation, a slice of bread B is inserted into one of the slots 14, or two slices of bread are inserted, one each into the separate slots. For ease of description, it is assumed that only one slice of bread B is inserted into one of the slots 14. When first inserted into the toaster 10, the bread B rests on the top surface of the bread bracket 34 for the bread carriage 18 and the bread B extends partly out of the slot 14.

The actuation handle 20 is then pressed downward by a user. Downward movement of the actuation handle 20 causes a corresponding downward movement of the bread carriage 18, allowing the bread B to lower into the slot 14 of the toaster 10.

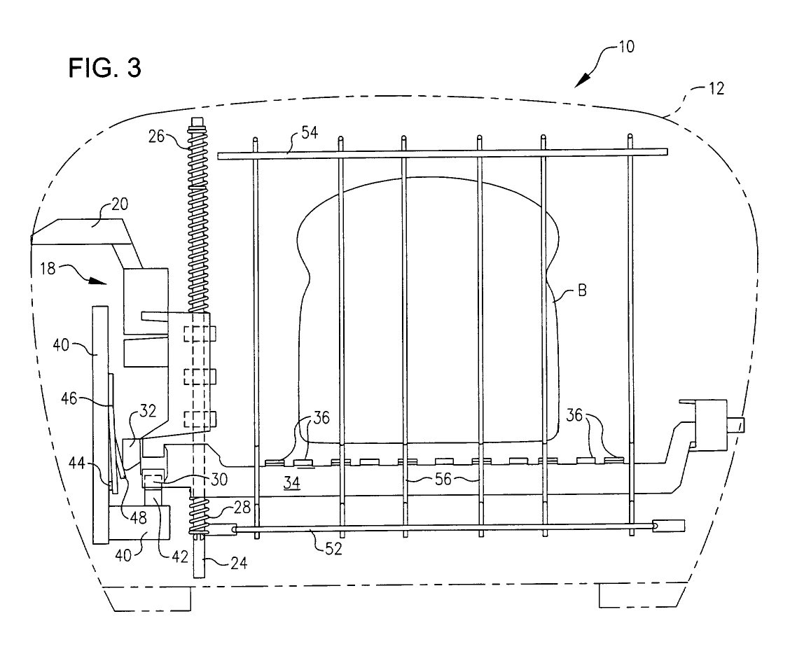

The bread carriage 18 continues its movement downward until the abutment 32 comes into contact with the spring contact 46. Further movement downward of the bread carriage 18 causes the spring contact 46 to bend toward and engage the supply contact 44 (FIG. 3), thus supplying power to heating elements (not shown, but known in the art) for the toaster 10. Substantially simultaneous with the-closing of the spring contact 46 into contact with the supply contact 44, the electromagnetic contact 30 engages the electromagnetic latch 42. The electromagnetic latch 42 is energized, for example by an auxiliary switch that is engaged by downward movement of the bread carriage 18. The energized electromagnetic latch 42 maintains contact with the electromagnetic contact 30, thus holding down the bread carriage 18 during a toasting cycle. The electronic circuitry of the toaster 10 would normally include suitable control elements to control the toasting cycle during normal operation, such as timers or color control systems. After a toasting cycle has been completed, power to the electromagnetic latch 42 is cut, and the electromagnetic contact 30 is released. This release of power permits the bread carriage 18 to return upward under the bias of the lower spring 28.

The operation of the toaster 10 thus far described is known in the art, and the components of the bread carriage 18, the actuation handle 20, and the electronic components of the toaster thus described may be substituted with other conventional toaster components. As an example, the bread carriage 18 may be latched down by a mechanical latching mechanism, instead of the electromagnetic latch 42. Other variations are possible. However, the present invention has particular relevance to a toaster that includes a bread carriage that, upon downward movement, causes power to be supplied to heating elements for the toaster.

In accordance with the present invention, bread supports are supplied that are configured to support a slice of bread B so that the slice of bread does not travel fully downward with the bread carriage 18 during its downward movement. Specifically, the bread B does not move downward with the bread carriage 18 during the portion of the downward stroke of the bread carriage in which the bread carriage engages the spring contacts 46 or otherwise energizes the heating elements. In this manner, once the toasting cycle has been completed, the bread carriage 18 may be released, and may travel upward a sufficient amount to release power to the heating elements prior to engaging the bread B. In this manner, if the bread is lodged within the slot 14, it cannot prevent the bread carriage 18 from releasing power to the heating elements.

The bread support may be supplied in any one of a number of different ways, but preferably is provided by some form of supports that extend in the pathway of the bread but do not interfere with downward movement of the bread carriage 18. The bread support may, for example, move into the pathway of the bread as a result of downward movement of the bread carriage 18. In accordance with one aspect of the present invention, the bread support is supplied on wire rack guides 50. Wire grid toast guides, also known as wire grills for toasters, are well known. In general, as a piece of bread is lowered into a toaster, wire grid toast guides move inwardly from opposite sides of the bread to gently center and hold the bread in position as it is being toasted. These wire grid toast guides typically pivot about a pivot point at the base of the toaster. The pivoting action is produced as a user mechanically pushes the actuation handle 20 on the toaster from an up position to a down position to lower the bread carriage 18 and bread into the toaster.

In the present embodiment, the wire grid toast guides 50 rotate around lower bars 52. Upper bars 54 extend horizontally along upper portions of the wire grid toast guides 50. In conventional wire grid toast guides, vertical bars extend between members similar to the lower and upper bars 52, 54. In accordance with one aspect of the present invention, vertical bars 56 of the wire grid toast guides 50 extend upward between the lower bars 52 and the upper bars 54 and include elbows 58 extending outward from a lower portion of the vertical bars 56 to horizontal supports 60. The vertical bars 56 then extend upward from the opposite sides of the horizontal supports 60. For this embodiment, the horizontal supports 60 serve as the bread supports of the present invention. As used herein, “horizontal” is meant to describe a structure that extends outward from the wire grid toast guides sufficiently to capture bread as the bread is moved downward by the bread carriage.

The horizontal supports 60 are arranged so that they extend between and do not interfere with the alternatingly offset gear tooth pattern 36 on the bread bracket 34. In this manner, the bread bracket 34 (and therefore the bread carriage 18) may be moved downward between the horizontal supports 60, without the horizontal supports interfering with the downward movement. The horizontal supports 60 extend inward far enough, however, so that the bread B may rest on the horizontal supports, and in fact cannot extend beyond the horizontal supports.

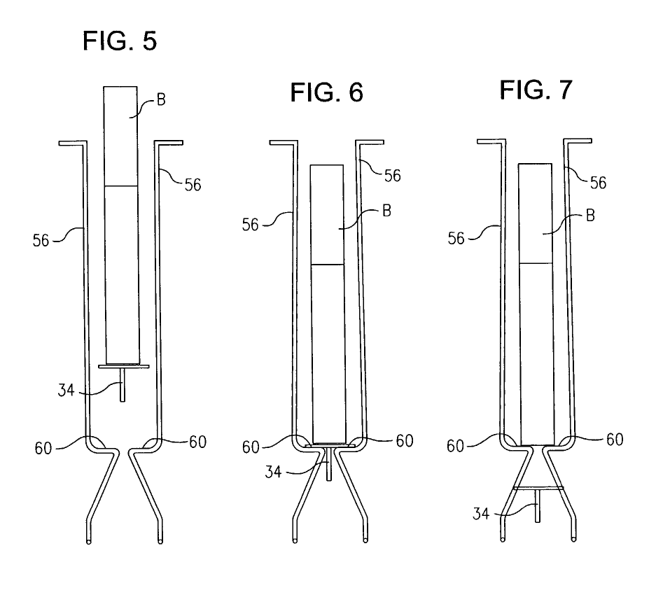

In operation of the toaster 10 with the wire grid toast guides 50, a user places a slice of bread B into the toaster so that the bread rests on the top of the bread bracket 34, as is shown in FIGS. 2 and 5. The actuation handle 20 is then pressed down by the user until the bread comes into contact with the horizontal supports 60 (FIG. 6). During this movement, the upper portions of the wire grid toast guides 50 move inward in a manner known in the art. For example, many toasters include a wire that is engaged by the bread carriage as the bread carriage is lowered into the toaster. The wire loops upward and is attached to the upper portions of the wire toast guides 50. When engaged, the wire pulls the upper portions inward.

The actuation handle 20 continues beyond this point, driving the bread carriage 18 further downward, but the bread does not move any lower because it is supported by the horizontal supports 60 (FIGS. 3 and 7). At the bottom of its movement downward, the bread carriage 18 engages the spring contact 46, energizing the heating elements. The bread carriage 18 is locked into place by the electromagnetic latch 42.

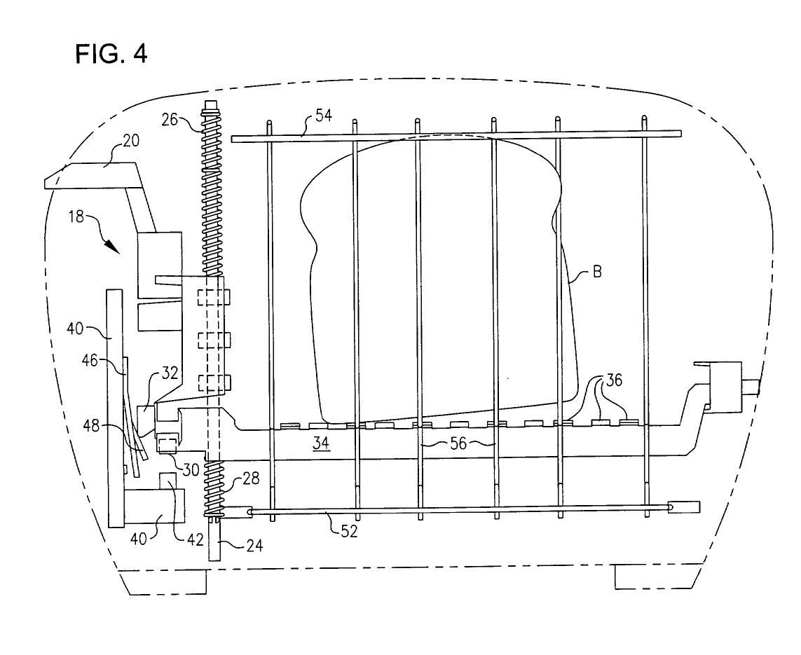

After the toasting cycle is completed, the electromagnetic latch 42 releases the bread carriage 18, and the bread carriage is free to move upward and release the spring contact 46, thus cutting power to the heating elements. Preferably, the power is cut to the heating elements prior to the bread B being engaged by the bread carriage 18. However, the release of power to the heating elements may occur substantially simultaneous with engagement of the bread, or slightly afterward. However, by fully cutting power to the heating elements prior to the bread carriage 18 engaging the bread, the toaster 10 is assured that a wedged piece of bread B (FIG. 4) will not prevent cutting of power to the heating elements.

If a piece of bread is wedged, such as is shown in FIG. 4, then the spring contact 46 has already been released when the bread carriage engages the wedged bread, and the bread carriage 18, even if it gets stuck because of the wedged bread, does not cause the heating elements to continue to burn. A user may then safely reach into the toaster (preferably after cooling of the heating elements) to dislodge the bread and release the bread carriage 18.

If desired, the bread supports could be attached to the housing or frame for the toaster 10, and extend into the path of the bread B. However, the embodiment shown and described does not require additional attachment of elements to the housing 12, which may be difficult to manufacture, or may interfere with providing a smooth, aesthetic surface for the outer surface of the toaster 10.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

What is claimed is:

1. A toaster, comprising:
a housing;
at least one heating element within the housing;
a bread carriage configured to support and lower bread into the housing;
a switch mechanism that is arranged and configured to supply power to the at least one heating element when the bread carriage is in a lower position; and
a bread support mounted on a wire grid toast guide for the toaster and that is configured and arranged to engage and support bread that is being lowered into the housing by the bread carriage prior to the bread carriage reaching the lower position.

2. The toaster of claim 1, wherein the bread carriage, the bread support, and the switch mechanism are arranged such that when the bread carriage is raised from the lowered position and engages bread on the bread support, the switch mechanism no longer supplies power to the heating element.

3. The toaster of claim 1, wherein the bread support comprises a horizontal support that is bent out of the wire grid toast guide.

4. The toaster of claim 1, further comprising a plurality of wire grid toast guides for the toaster, and wherein the bread support comprises a support mounted on each of the wire grid toast guides.

5. The toaster of claim 4, wherein each of the supports comprises a horizontal support that is bent out of the respective wire grid toast guide.

6. The toaster of claim 1, wherein the bread carriage comprises an abutment and the switch mechanism is engaged by the abutment in the lower position to cause actuation of the switch mechanism.

7. The toaster of claim 6, wherein the switch mechanism comprises contacts that are pressed together by the abutment.

8. The toaster of claim 6, wherein raising the bread carriage from the lower position causes the abutment to release the switch mechanism prior to the bread being engaged by the bread carriage.

9. A toaster, comprising:
a bread carriage for lowering bread into the toaster;
a wire toast guide configured to extend on opposite sides of a piece of bread as it is lowered into the toaster; and
a bread support mounted on the wire toast guide for capturing bread as the bread is lowered by the bread carriage such that the bread carriage separates from bread captured by the bread support as the bread carriage continues to lower past the bread support.

10. The toaster of claim 9, further comprising:
a heating element mounted within the toaster; and
a switch that is actuated by the bread carriage as the bread carriage lowers past the bread support, actuation of the switch providing power to the heating element.

11. The toaster of claim 10, wherein the bread carriage comprises an abutment and the switch is engaged by the abutment in the lower position to cause actuation of the switch.

12. The toaster of claim 11, wherein the switch mechanism comprises contacts that are pressed together by the abutment.

13. The toaster of claim 10, wherein the bread carriage, the bread support, and the switch mechanism are arranged such that when the bread carriage is raised from the lowered position and engages bread on the bread support, the switch mechanism no longer supplies power to the heating element.

14. The toaster of claim 13, wherein raising the bread carriage from the lower position causes the abutment to release the switch mechanism prior to the bread being engaged by the bread carriage.

15. The toaster of claim 9, wherein the bread support comprises a horizontal support that is bent out of the wire grid toast guide.

16. The toaster of claim 9, further comprising a plurality of wire grid toast guides for the toaster, and wherein the bread support comprises a support mounted on each of the wire grid toast guides.

17. The toaster of claim 16, wherein each of the supports comprises a horizontal support that is bent out of the respective wire grid toast guide.
